(19) United States
(12) Patent Application Publication
(10) Pub. No.: US 2025/0094663 A1
(43) Pub. Date: Mar. 20, 2025

(54) STATIC VOLTAGE STABILITY MARGIN EVALUATION METHOD AND SYSTEM, AND TERMINAL DEVICE

(71) Applicant: SOUTHEAST UNIVERSITY, Nanjing (CN)

(72) Inventors: Shuai LU, Nanjing (CN); Yuan LI, Nanjing (CN); Wei GU, Nanjing (CN); Yijun XU, Nanjing (CN); Shixing DING, Nanjing (CN); Ruizhi YU, Nanjing (CN)

(21) Appl. No.: 18/559,292

(22) PCT Filed: Mar. 13, 2023
(86) PCT No.: PCT/CN2023/081146

§ 371 Date: Nov. 6, 2023

(30) Foreign Application Priority Data
Feb. 9, 2023 (CN) 202310086533.5

(51) Int. Cl. G06F 30/20; H02J 3/00; H05B 1/02

(52) U.S. Cl. CPC G06F 30/20; H02J 3/00; H05B 1/0275; H02J 2203/20

(57) ABSTRACT

A static voltage stability margin evaluation method and system, and a terminal device are related to the field of integrated energy system operation. The method includes the following steps: establishing a thermal dynamic model of a heating system; establishing a thermoelectric coupling device model; establishing a static voltage stability margin model of an electric power system that considers thermal dynamics of the heating system; and solving the model to obtain a voltage stability margin. In the present invention, a static voltage stability margin that considers thermal dynamics of a heating system can be obtained, and a Pareto boundary of the static voltage stability margin that considers the thermal dynamics can be obtained through a dual-objective nonlinear optimization method, so that an impact of thermoelectric coupling on voltage stability and an impact of thermal inertia of the heating system on a voltage stability margin can be revealed.

### TECHNICAL FIELD

The present invention relates to the field of integrated energy system operation, and specifically, to a static voltage stability margin evaluation method and system, and a terminal device.

### BACKGROUND

An integrated energy system integrates a plurality of energy subsystems such as gas, electric power, heating, and transportation, and can achieve, through mutual collaboration between the plurality of energy subsystems, cascade utilization of primary energy, improve a utilization rate of renewable energy, and achieve coordination and complementation of multi-energy loads, to reach a goal of energy conservation and emission reduction of the energy system. A static voltage stability margin is to quantify a voltage stability limit by measuring a distance between a specified operating condition and a safety limit point, and has been widely applied to operation and planning of an electric power system.

In the integrated energy system, coupling relationships between a plurality of energy flows are very complex, and there is interdependence between an electric power network and a thermal network. As a result, the static voltage stability margin is no longer applicable. Therefore, for the complex energy flow coupling relationships and thermal dynamic characteristics of the integrated energy system, establishing static voltage stability margin evaluation that considers thermal dynamics of a heating system and that is applicable to the integrated energy system is an urgent problem that needs to be solved in engineering applications. However, in existing technologies, the electric power system or the heating system is often considered alone, a coupling relationship and mutual influence between the electric power system and the heating system cannot be considered, and physical characteristics of a voltage stability margin of a thermoelectric integrated energy system are also unclear.

### SUMMARY

For shortcomings of the existing technologies, a purpose of the present invention is to provide a static voltage stability margin evaluation method and system, and an apparatus that consider thermal dynamics of a heating system. In the present invention, a Pareto boundary of a static voltage stability margin that considers thermal dynamics of a heating system in different scenarios is obtained through a dual-objective optimization method. Through the provided method, an impact of thermoelectric coupling on voltage stability and an impact of thermal inertia of the heating system on the voltage stability margin can be revealed, thereby effectively characterizing interaction between an electric power network and a thermal network in an integrated energy system, and implementing evaluation of a static voltage stability margin in the integrated energy system.

The objective of the present invention can be achieved through the following technical solutions.

A first aspect of this application discloses a static voltage stability margin evaluation method, including:
establishing a thermal dynamic model of a heating system based on temperature transmission of a heating network pipe and thermal dynamics of a building; establishing a thermoelectric coupling device model based on operation and a coupling constraint of a thermoelectric coupling device;
establishing, based on an electric load growth mode and a thermal load growth mode, a static voltage stability margin model:

max(λ_{E},λ_{H})

s.t. g_{E}(P,Q,V,θ,λ_{E})≤0

g_{H}(H,T,m,λ_{H})≤0

g_{EH}(P,H)≤0
where λ_{E} and λ_{H} are respectively an electric load coefficient and a thermal load coefficient; P and Q are respectively active/reactive power of an electric generator or a branch; V and θ are respectively a voltage and a phase of a bus; H is thermal energy; T is a water temperature or a room temperature; m is a mass flow rate; and g_{E}(⋅)≤0, g_{H}(⋅)≤0, and g_{EH}(⋅)≤0 are respectively constraints of an electric power system, the heating system, and a thermoelectric coupling relationship; and
solving the static voltage stability margin model to obtain a voltage stability margin.

Further, the establishing, based on an electric load growth mode and a thermal load growth mode, a static voltage stability margin model further includes the following steps:
establishing an electric load growth mode model:

$${P}_{L , {c}_{1}}^{i , t} = ( 1 + {λ}_{E} ) {P}_{L \cdot {c}_{0}}^{i , t} , {Q}_{L , {c}_{1}}^{i , t} = ( 1 + {λ}_{E} ) {Q}_{L \cdot {c}_{0}}^{i , t}$$

where P_{L,c}_{₀}^{i,t} and P_{L,c}_{₁}^{i,t} are respectively active power of a current operating point and a safety limit point; Q_{L,c}_{₀}^{i,t} and Q_{L,c}_{₁}^{i,t} are respectively reactive power of the current operating point and the safety limit point; and λ_{E} is the electric load coefficient;
establishing a thermal load growth mode model:

$${H}_{L , {c}_{1}}^{k , t} = ( 1 + {λ}_{H} ) {H}_{L \cdot {c}_{0}}^{k , t}$$

where H_{L,c}_{₀}^{k,t} and H_{L,c}_{₁}^{k,t} are respectively thermal loads at the current operating point and the safety limit point; and λ_{H} is the thermal load coefficient;
establishing a hydraulic regulation strategy model:

$${m}_{p , {c}_{1}}^{j} = \{ \begin{matrix}( 1 + {λ}_{H} ) {m}_{p , {c}_{0}}^{j} , & if ( 1 + {λ}_{H} ) {m}_{p , {c}_{0}}^{j} \leq {A}_{p}^{j} {\overline{v}}_{p} , ∀ j \\ {A}_{p}^{j} {\overline{v}}_{p} & else\end{matrix} .$$

where m_{p,c}_{₀}^{j} and m_{p,c}_{₁}^{j} are respectively mass flow rates of a pipe J at the current operating point and the safety limit point; and v̅ₚ is a water velocity upper limit to avoid hydraulic instability and pipe erosion; and
establishing the static voltage stability margin model based on the electric load growth mode model, the thermal load growth mode model, and the hydraulic regulation strategy model.

Further, the establishing a thermal dynamic model of a heating system includes the following steps:
establishing a temperature transmission model of the heating network pipe:

$${T}_{out}^{j , t} = {β}_{p}^{j} ( {k}_{p}^{j} {T}_{in}^{j , t - {γ}_{p}^{j}} + ( 1 - {k}_{p}^{j} ) {T}_{in}^{j , t - {γ}_{p}^{j} - 1} ) + ( 1 - {β}_{p}^{j} ) {T}_{amb}^{t}$$

where t is a scheduled period set; j is a pipe set; parameters γₚ^{j} and kₚ^{j} are coefficients of the pipe j that are related to a transmission delay; βₚ^{j} is a heat preservation coefficient; T_{amb}^{t} is a pipe ambient temperature at a moment t; Tᵢₙ^{j,t} and Tₒᵤₜ^{j,t} are respectively temperatures of a heat medium at a pipe inlet and outlet at the moment t; and
calculation formulas of the parameters γₚ^{j}, kₚ^{j}, and βₚ^{j} are as follows:

$$\{ \begin{matrix}{γ}_{p}^{j} = ⌈ {ρ}_{w} {A}_{p}^{j} {L}_{p}^{j} / ( {m}_{p}^{j} Δ t ) ⌉ - 1 \\ {k}_{p}^{j} = {γ}_{p}^{j} + 1 - {ρ}_{w} {A}_{p}^{j} {L}_{p}^{j} / ( {m}_{p}^{j} Δ {t}_{h} ) \\ {β}_{p}^{j} = 1 - exp ( - {ζ}_{p}^{j} Δ t / ( {ρ}_{w} {c}_{w} {A}_{p}^{j} ) ( {γ}_{p}^{j} + 3 / 2 - {k}_{p}^{j} ) )\end{matrix}$$

where Δt is a time interval; ρ_{w} is a density of the heat medium; c_{w} is a specific heat capacity of the heat medium; Aₚ^{j} is a cross-sectional area of the pipe j; Lₚ^{j} is a length of the pipe j; ζₚ^{j} is a pipe heat loss coefficient; mₚ^{j} is a mass flow rate of the heat medium of the pipe; and ┌⋅┐ is a round-up function; and
establishing a thermal dynamic model of the building:

$${T}_{b}^{k , t} = {α}_{b}^{k} {T}_{b}^{k , t - 1} + {β}_{b}^{k} {H}_{L}^{k , t} + {γ}_{b}^{k} {T}_{out}^{t}$$

where k is a building set; and α_{b}^{k}, β_{b}^{k} and γ_{b}^{k} are parameters that depend on a heat capacity and thermal resistance of the building.

Further, the solving the static voltage stability margin model to obtain a voltage stability margin includes the following steps:
optimizing the static voltage stability margin model as:

λ_{E}(ε)=max λ_{E}

s.t. λ_{H}=ε

g_{E}≤0,g_{H}≤0,g_{EH}≤0
where ε is a constant for predefining λ_{H}; and
initializing ε=0, Flag=1, k=0, and Aε, and performing solving according to the following cycle step,
where the cycle step includes:
updating λ_{H}^{k}←ε, and calculating a mass flow rate m_{p,c}_{₁}^{j}, and parameters γₚ^{j}, kₚ^{j}, and βₚ^{j};
solving the optimized static voltage stability margin model; and if there is a solution, updating λ_{E}^{k}←λ_{E}(λ_{H}^{k}); otherwise, updating Flag←0;
updating k←k+1, ε←ε+Δε; and
if Flag=1, repeating the cycle step; or if Flag=0, exiting the cycle step.

Further, the thermoelectric coupling device model includes an operation constraint of a combined heat and power unit, a coupling constraint between the combined heat and power unit and a heating network, and a water temperature constraint of the heating system.

Further, the coupling constraint between the combined heat and power unit and the heating network is as follows:

$${H}_{chp}^{i , t} = {c}_{w} {m}_{src}^{i , t} ( {T}_{src , s}^{i , t} - {T}_{src , r}^{i , t} )$$

where m_{src}^{i,t} is a mass flow rate of a heat source; and T_{src,s}^{i,t} and T_{src,r}^{i,t} are respectively a supply water temperature and a return water temperature of the heat source.

Further, the water temperature constraint of the heating system is as follows:

T_{src,s}ⁱ≤T_{src,s}^{i,t}≤T̅_{src,s}ⁱ,T_{src,r}ⁱ≤T_{src,r}^{i,t}≤T̅_{src,r}ⁱ

where T_{src,s}ⁱ and T̅_{src,s}ⁱ are respectively a lower limit and an upper limit of a supply water temperature of a heat source; and T_{src,r}ⁱ and T̅_{src,r}ⁱ are respectively a lower limit and an upper limit of a return water temperature of the heat source.

A second aspect of this application discloses a static voltage stability margin evaluation system using the static voltage stability margin evaluation method according to the first aspect, including:
a thermal dynamic model module of a heating system, configured to establish a thermal dynamic model of the heating system based on temperature transmission of a heating network pipe and thermal dynamics of a building;
a thermoelectric coupling device model module, configured to establish a thermoelectric coupling device model based on operation and a coupling constraint of a thermoelectric coupling device;
a static voltage stability margin model module, configured to establish, based on an electric load growth mode and a thermal load growth mode, a static voltage stability margin model; and
a calculation module, configured to solve the static voltage stability margin model based on the thermal dynamic model module of the heating system, the thermoelectric coupling device model module, and the static voltage stability margin model module, to obtain a voltage stability margin.

A third aspect of this application discloses a terminal device, including a memory, a processor, and a computer program stored in the memory and executable on the processor, the processor, when loading and executing the computer program, using the static voltage stability margin evaluation method according to the first aspect.

A fourth aspect of this application discloses a computer-readable storage medium, storing a computer program, the computer program, when being loaded and executed by a processor, using the static voltage stability margin evaluation method according to the first aspect.

The present invention has the following beneficial effects:

In the present invention, a Pareto boundary of a static voltage stability margin that considers thermal dynamics of a heating system in different scenarios is obtained through a dual-objective optimization method. Through the provided method, an impact of thermoelectric coupling on voltage stability and an impact of thermal inertia of the heating system on the voltage stability margin can be revealed, thereby effectively characterizing interaction between an electric power network and a thermal network in an integrated energy system, and implementing evaluation of a static voltage stability margin in the integrated energy system.

### BRIEF DESCRIPTION OF THE DRAWINGS

The following further describes the present invention in detail with reference to the accompanying drawings.

FIG. 1 is a structural diagram of an integrated energy system according to the present invention;

FIG. 2 is a flowchart of a static voltage stability margin evaluation method that considers thermal dynamics of a heating system according to the present invention;

FIG. 3 is a structural diagram of an integrated energy system according to Embodiment 2 of the present invention;

FIG. 4 shows a Pareto frontier of a static voltage stability margin evaluation result that considers thermal dynamics of a heating system according to Embodiment 2 of the present invention;

FIG. 5 shows an operating point of a CHP unit when λ_{H}=1.5 in a static voltage stability margin evaluation result that considers thermal dynamics of a heating system according to Embodiment 2 of the present invention;

FIG. 6 shows active power output results of a generator in four scenarios when λ_{H}=1.5 according to Embodiment 2 of the present invention; and

FIG. 7 shows thermal load results in four scenarios when λ_{H}=1.5 according to Embodiment 2 of the present invention.

### DETAILED DESCRIPTION

The technical solutions of embodiments of the present invention are clearly and completely described below with reference to the accompanying drawings in the embodiments of the present invention. Obviously, the described embodiments are merely a part rather than all of the embodiments of the present invention. All other embodiments obtained by a person of ordinary skill in the art based on the embodiments of the present invention without creative efforts shall fall within the protection scope of the present invention.

In the descriptions of this specification, descriptions of reference terms such as “an embodiment”, “an example”, and “a specific example” mean that specific features, structures, materials, or characteristics that are described with reference to the embodiment or the example are included in at least one embodiment or example of the present invention. In this specification, schematic descriptions of the foregoing terms do not necessarily point at a same embodiment or example. In addition, the described specific features, structures, materials, or characteristics may be combined in a proper manner in any one or more of the embodiments or examples.

### Embodiment 1

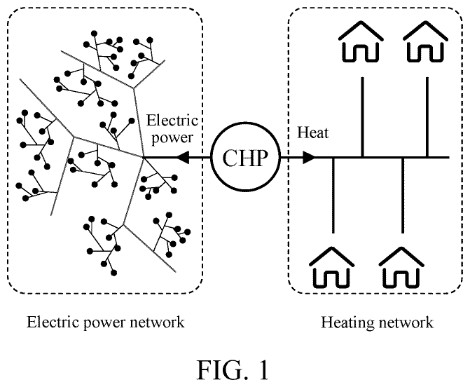

This embodiment is used in an integrated energy system, and a structure of the integrated energy system is shown in FIG. 1.

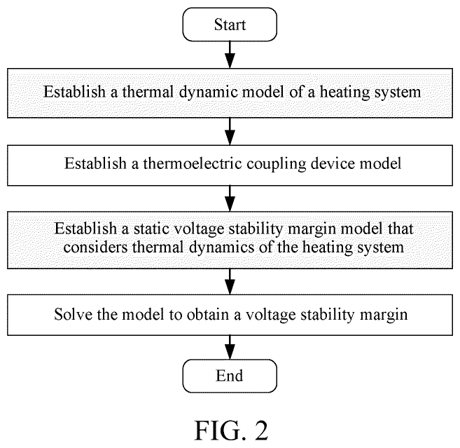

As shown in FIG. 2, a static voltage stability margin evaluation method that considers thermal dynamics of a heating system includes the following steps.

S1: Establish a thermal dynamic model of a heating system.

S11: Establish a temperature transmission model of a heating network pipe, where the temperature transmission model of the heating network pipe is as follows:

$${T}_{out}^{j , t} = {β}_{p}^{j} ( {k}_{p}^{j} {T}_{in}^{j , t - {γ}_{p}^{j}} + ( 1 - {k}_{p}^{j} ) {T}_{in}^{j , t - {γ}_{p}^{j} - 1} ) + ( 1 - {β}_{p}^{j} ) {T}_{amb}^{t}$$

where t is a scheduled period set; j is a pipe set; parameters γₚ^{j} and kₚ^{j} are coefficients of the pipe j that are related to a transmission delay; βₚ^{j} is a heat preservation coefficient; T_{amb}^{t} is a pipe ambient temperature at a moment t; Tᵢₙ^{j,t} and Tₒᵤₜ^{j,t} are respectively temperatures of a heat medium at a pipe inlet and outlet at the moment t; and
calculation formulas of the parameters γₚ^{j}, kₚ^{j}, and βₚ^{j} are as follows:

$$\{ \begin{matrix}{γ}_{p}^{j} = ⌈ {ρ}_{w} {A}_{p}^{j} {L}_{p}^{j} / ( {m}_{p}^{j} Δ t ) ⌉ - 1 \\ {k}_{p}^{j} = {γ}_{p}^{j} + 1 - {ρ}_{w} {A}_{p}^{j} {L}_{p}^{j} / ( {m}_{p}^{j} Δ {t}_{h} ) \\ {β}_{p}^{j} = 1 - exp ( - {ζ}_{p}^{j} Δ t / ( {ρ}_{w} {c}_{w} {A}_{p}^{j} ) ( {γ}_{p}^{j} + 3 / 2 - {k}_{p}^{j} ) )\end{matrix}$$

where Δt is a time interval; ρ_{w} is a density of the heat medium; c_{w} is a specific heat capacity of the heat medium; Aₚ^{j} is a cross-sectional area of the pipe j; Lₚ^{j} is a length of the pipe j; λₚ^{j} is a pipe heat loss coefficient; mₚ^{j} is a mass flow rate of the heat medium of the pipe; and ┌⋅┐ is a round-up function.

S12: Establish a thermal dynamic model of a building:

$${T}_{b}^{k , t} = {α}_{b}^{k} {T}_{b}^{k , t - 1} + {β}_{b}^{k} {H}_{L}^{k , t} + {γ}_{b}^{k} {T}_{out}^{t}$$

where k is a building set; and α_{b}^{k}, β_{b}^{k} and γ_{b}^{k} are parameters that depend on a heat capacity and thermal resistance of the building.

S2: Establish a thermoelectric coupling device model.

S21: Establish an operation constraint of a combined heat and power unit.

S211: Establish an operation constraint of a condensing combined heat and power unit:

$${a}_{chp}^{i , j} {P}_{chp}^{i , t} + {b}_{chp}^{i , j} {H}_{chp}^{i , t} \leq {c}_{chp}^{i , j} ∀ j ∈ J$$

where i is a unit set; j is a set of limit points of a feasible region; a_{chp}^{i,j}, b_{chp}^{i,j}, and c_{chp}^{i,j} are unit parameters; and P_{chp}^{i,t} and H_{chp}^{i,t} are respectively electric power and thermal power output by the CHP unit.

S212: Establish an operation constraint of a back pressure combined heat and power unit:

P_{chp}^{i,t}=k_{chp}^{i,t}H_{chp}^{i,t}
where k_{chp}^{i,j} is a heat-power ratio of the CHP unit.

S22: Establish a coupling constraint between the combined heat and power unit and a heating network:

$${H}_{chp}^{i , t} = {c}_{w} {m}_{src}^{i , t} ( {T}_{src , s}^{i , t} - {T}_{src , r}^{i , t} )$$

where m_{src}^{i,t} is a mass flow rate of a heat source; and T_{src,s}^{i,t} and T_{src,r}^{i,t} are respectively a supply water temperature and a return water temperature of the heat source.

S23: Establish a water temperature constraint of the heating system:

T_{src,s}ⁱ≤T_{src,s}^{i,t}≤T̅_{src,s}ⁱ,T_{src,r}ⁱ≤T_{src,r}^{i,t}≤T̅_{src,r}ⁱ
where T_{src,s}ⁱ and T̅_{src,s}ⁱ (or T_{src,r}ⁱ and T̅_{src,r}ⁱ) are respectively a lower limit and an upper limit of a supply water temperature (or return water temperature) of a heat source.

S3: Establish a static voltage stability margin model that considers thermal dynamics of the heating system.

S31: Establish a load growth mode model.

S311: Establish an electric load growth mode model:

$${P}_{L , {c}_{1}}^{i , t} = ( 1 + {λ}_{E} ) {P}_{L \cdot {c}_{0}}^{i , t} , {Q}_{L , {c}_{1}}^{i , t} = ( 1 + {λ}_{E} ) {Q}_{L \cdot {c}_{0}}^{i , t}$$

where P_{L,c}_{₀}^{i,t} and P_{L,c}_{₁}^{i,t} (or Q_{L,c}_{₀}^{i,t} and Q_{L,c}_{₁}^{i,t}) are respectively active (or reactive) power of a current operating point and a safety limit point; and λ_{E} is an electric load coefficient.

S312: Establish a thermal load growth mode model based on a current operating point:

$${H}_{L , {c}_{1}}^{k , t} = ( 1 + {λ}_{H} ) {H}_{L \cdot {c}_{0}}^{k , t}$$

where H_{L,c}_{₀}^{k,t} and H_{L,c}_{₁}^{k,t} are respectively thermal loads at the current operating point and the safety limit point; and λ_{H} is a thermal load coefficient.

S313: Establish a hydraulic regulation strategy model:

$${m}_{p , {c}_{1}}^{j} = \{ \begin{matrix}( 1 + {λ}_{H} ) {m}_{p , {c}_{0}}^{j} , & if ( 1 + {λ}_{H} ) {m}_{p , {c}_{0}}^{j} \leq {A}_{p}^{j} {\overline{v}}_{p} , ∀ j \\ {A}_{p}^{j} {\overline{v}}_{p} & else\end{matrix} .$$

where m_{p,c}_{₀}^{j} and m_{p,c}_{₁}^{j} are respectively mass flow rates of a pipe j at the current operating point and the safety limit point; and v̅ₚ is a water velocity upper limit to avoid hydraulic instability and pipe erosion.

S32: Establish the static voltage stability margin model that considers the thermal dynamics of the heating system, where a mathematical form thereof is shown in the following formula:

max(λ_{E},λ_{H})

s.t. g_{E}(P,Q,V,θ,λ_{E})≤0

g_{H}(H,T,m,λ_{H})≤0

g_{EH}(P,H)≤0
where λ_{E} and λ_{H} are respectively an electric load coefficient and a thermal load coefficient; P and Q are respectively active/reactive power of an electric generator or a branch; V and θ are respectively a voltage and a phase of a bus; H is thermal energy; T is a water temperature or a room temperature; m is a mass flow rate; and g_{E}(⋅)≤0, g_{H}(⋅)≤0, and g_{EH}(⋅)≤0 are respectively constraints of an electric power system, the heating system, and a thermoelectric coupling relationship; and

S4: Solve the model to obtain a voltage stability margin.

S41: Convert a dual-objective optimization model established in S32 into:

λ_{E}(ε)=max λ_{E}

s.t. λ_{H}=ε

g_{E}≤0,g_{H}≤0,g_{EH}≤0
where ε is a constant for predefining λ_{H}.

S42: Solve the model established in S41 by using the following algorithm:

S421: Initialize ε=0, Flag=1, k=0, and Δε.

S422: Update λ_{H}^{k}←ε, and calculate a mass flow rate m_{p,c}_{₁}^{j}, and parameters γₚ^{j}, kₚ^{j}, and βₚ^{j}.

S423: Solve the model in step S41; and if there is one solution, update λ_{E}^{k}←λ_{E}(λ_{H}^{k}); otherwise, update Flag←0.

S424: Update k←k+1, ε←ε+Δε.

S425: If Flag=1, repeat steps S422 to S424; or if Flag=0, exit the cycle.

### Embodiment 2

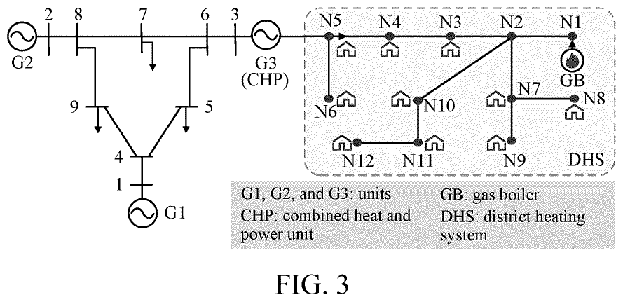

An integrated energy system in this embodiment is formed by a 9-node electric power system and a 12-node heating system. As shown in FIG. 3, the system includes two 300 MW coal-fired units, one 300 MW CHP unit, and one gas boiler with a capacity of 300 MW, a scheduled time interval is 1 h, total scheduled time is 24 h, a supply temperature of a heat source is set to constant (90° C.), and a room temperature is set to an ideal value (20° C.). A step size of λ_{H}, namely, Δε, is set to 0.05.

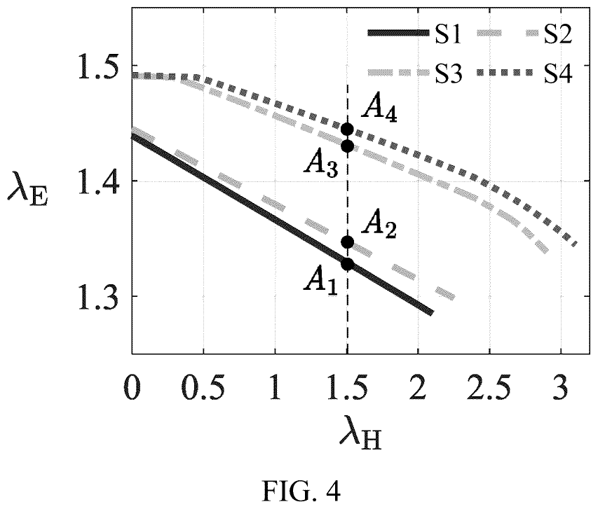

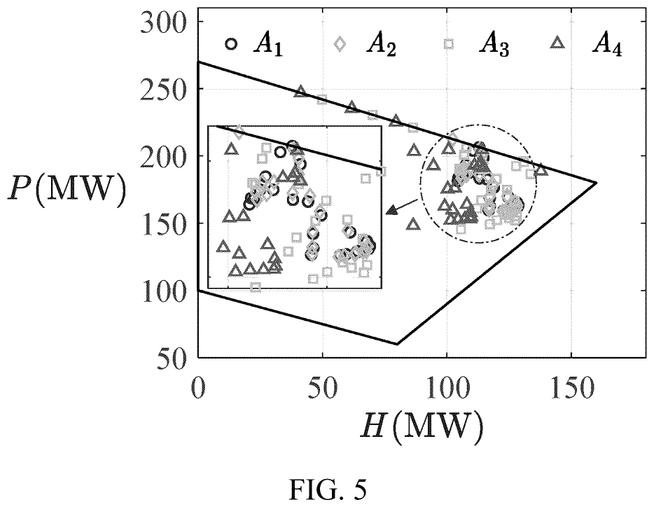

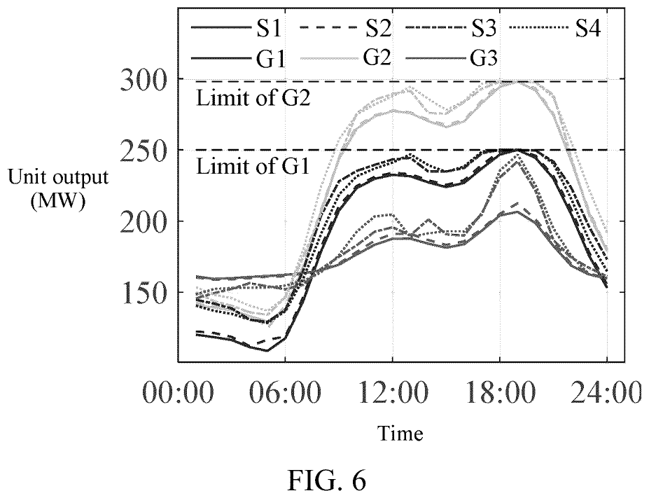

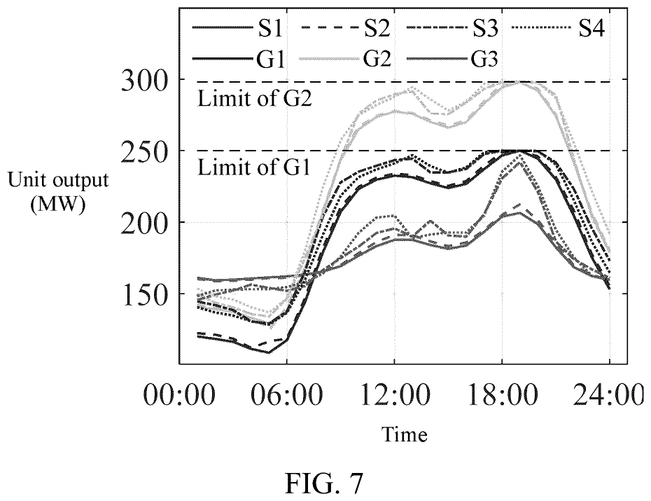

According to the steps of the present invention, a static voltage stability margin that considers thermal dynamics of a heating system is solved. A Pareto frontier obtained by solving is shown in FIG. 4. Distribution of operating points of the CHP unit when λ_{H}=1.5 in a static voltage stability margin result that considers the thermal dynamics of the heating system is shown in FIG. 5. Active power output results and thermal load results of a generator in four scenarios when λ_{H}=1.5 are shown in FIG. 6 and FIG. 7 respectively. It can be seen that, a thermoelectric coupling relationship in an integrated thermoelectric energy system has a negative impact on voltage stability, but thermal inertia of a heating system (especially a building) can be used to improve an operating point of a combined heat and power apparatus, thereby improving a voltage stability margin of an electric power system.

Therefore, in the method, an electric power network constraint, a heating network constraint, and a building thermal load constraint of the integrated energy system can be comprehensively considered, thermal dynamic characteristics, thermoelectric coupling, and a voltage stability margin of the integrated thermoelectric energy system are accurately characterized, and interaction of an electric power network and a thermal network of the integrated energy system can be effectively characterized, to implement evaluation on a static voltage stability margin in the integrated energy system.

The embodiments of this application disclose a static voltage stability margin evaluation system, including:
a thermal dynamic model module of a heating system, configured to establish a thermal dynamic model of the heating system based on temperature transmission of a heating network pipe and thermal dynamics of a building;
a thermoelectric coupling device model module, configured to establish a thermoelectric coupling device model based on operation and a coupling constraint of a thermoelectric coupling device;
a static voltage stability margin model module, configured to establish, based on an electric load growth mode and a thermal load growth mode, a static voltage stability margin model; and
a calculation module, configured to solve the static voltage stability margin model based on the thermal dynamic model module of the heating system, the thermoelectric coupling device model module, and the static voltage stability margin model module, to obtain a voltage stability margin.

The embodiments of this application further disclose a terminal device, including a memory, a processor, and a computer program stored in the memory and executable on the processor, the processor, when executing the computer program, using any static voltage stability margin evaluation method in the foregoing embodiments.

The terminal device may be a computer device such as a desktop computer, a laptop computer, or a cloud server, and the terminal device includes but is not limited to a processor and a memory. For example, the terminal device may alternatively include input and output devices, a network access device, a bus, and the like.

The processor may be a central processing unit (CPU). Certainly, according to an actual use situation, the processor may be another general purpose processor, a digital signal processor (DSP), an application-specific integrated circuit (ASIC), a field programmable gate array (FPGA) or another programmable logical device, a discrete gate or a transistor logical device, a discrete hardware component, or the like. The general purpose processor may be a microprocessor, any conventional processor, or the like. This is not limited in this application.

The memory may be an internal storage unit of the terminal device, such as a hard disk or a memory of the terminal device, or an external storage device of the terminal device, such as a plug-in hard disk, a smart memory card (SMC), a secure digital card (SD), or a flash memory card (FC) equipped on the terminal device. The memory may alternatively be a combination of the internal storage unit of the terminal device and the external storage device. The memory is configured to store a computer program and other programs and data required by the terminal device. The memory may alternatively be configured to temporarily store data that has been output or that is to be output. This is not limited in this application.

By using the terminal device, any static voltage stability margin evaluation method in the foregoing embodiments is stored in the memory of the terminal device, and is loaded and executed on the processor of the terminal device for convenient use.

The embodiments of this application further disclose a computer-readable storage medium, storing a computer program, the computer program, when being executed by a processor, using any static voltage stability margin evaluation method in the foregoing embodiments.

The computer program may be stored in the computer-readable medium. The computer program includes computer program code. The computer program code can be in a form of source code, object code, executable file or some middleware form, etc. The computer-readable medium may include: any entity or apparatus that is capable of carrying the computer program code, a recording medium, a USB flash drive, a removable hard disk, a magnetic disk, an optical disc, a computer memory, a read-only memory (ROM), a random access memory (RAM), an electric carrier signal, a telecommunication signal and a software distribution medium, or the like. It should be noted that, the computer-readable medium includes but is not limited to the foregoing components.

By using the computer-readable storage medium, any static voltage stability margin evaluation method in the foregoing embodiments is stored in the computer-readable storage medium, and is loaded and executed on the processor for convenient storage and use of the foregoing method.

The foregoing shows and describes basic principles, main features of the present invention and advantages of the present invention. A person skilled in the art may understand that the present invention is not limited to the foregoing embodiments. Descriptions in the embodiments and this specification only illustrate the principles of the present invention. Various modifications and improvements are made in the present invention without departing from the spirit and the scope of the present invention, and these modifications and improvements shall fall within the protection scope of the present invention.

1. A static voltage stability margin evaluation method, comprising:
establishing a thermal dynamic model of a heating system based on temperature transmission of a heating network pipe and thermal dynamics of a building; establishing a thermoelectric coupling device model based on operation and a coupling constraint of a thermoelectric coupling device;
establishing, based on an electric load growth mode and a thermal load growth mode, a static voltage stability margin model:
max(λ_{E},λ_{H})
s.t. g_{E}(P,Q,V,θ,λ_{E})≤0
g_{H}(H,T,m,λ_{H})≤0
g_{EH}(P,H)≤0
wherein λ_{E} and λ_{H} are respectively an electric load coefficient and a thermal load coefficient; P and Q are respectively active/reactive power of an electric generator or a branch; V and θ are respectively a voltage and a phase of a bus; H is thermal energy; T is a water temperature or a room temperature; m is a mass flow rate; and g_{E}(⋅)≤0, g_{H}(⋅)≤0, and g_{EH}(⋅)≤0 are respectively constraints of an electric power system, the heating system, and a thermoelectric coupling relationship; and
solving the static voltage stability margin model to obtain a voltage stability margin.

2. The static voltage stability margin evaluation method according to claim 1, wherein the establishing, based on an electric load growth mode and a thermal load growth mode, a static voltage stability margin model further comprises the following steps:
establishing an electric load growth mode model:
$${P}_{L , {c}_{1}}^{i , t} = ( 1 + {λ}_{E} ) {P}_{L \cdot {c}_{0}}^{i , t} , {Q}_{L , {c}_{1}}^{i , t} = ( 1 + {λ}_{E} ) {Q}_{L \cdot {c}_{0}}^{i , t}$$
wherein P_{L,c}_{₀}^{i,t} and P_{L,c}_{₁}^{i,t} are respectively active power of a current operating point and a safety limit point; Q_{L,c}_{₀}^{i,t} and Q_{L,c}_{₁}^{i,t} are respectively reactive power of the current operating point and the safety limit point; and λ_{E} is the electric load coefficient;
establishing a thermal load growth mode model:
$${H}_{L , {c}_{1}}^{k , t} = ( 1 + {λ}_{H} ) {H}_{L \cdot {c}_{0}}^{k , t}$$
wherein H_{L,c}_{₀}^{k,t} and H_{L,c}_{₁}^{k,t} are respectively thermal loads at the current operating point and the safety limit point; and λ_{H} is the thermal load coefficient;
establishing a hydraulic regulation strategy model:
$${m}_{p , {c}_{1}}^{j} = \{ \begin{matrix}( 1 + {λ}_{H} ) {m}_{p , {c}_{0}}^{j} , & if ( 1 + {λ}_{H} ) {m}_{p , {c}_{0}}^{j} \leq {A}_{p}^{j} {\overline{v}}_{p} , ∀ j \\ {A}_{p}^{j} {\overline{v}}_{p} & else\end{matrix} .$$
wherein m_{p,c}_{₀}^{j} and m_{p,c}_{₁}^{j} are respectively mass flow rates of a pipe j at the current operating point and the safety limit point; and v̅ₚ is a water velocity upper limit to avoid hydraulic instability and pipe erosion; and
establishing the static voltage stability margin model based on the electric load growth mode model, the thermal load growth mode model, and the hydraulic regulation strategy model.

3. The static voltage stability margin evaluation method according to claim 2, wherein the establishing a thermal dynamic model of a heating system comprises the following steps:
establishing a temperature transmission model of the heating network pipe:
$${T}_{out}^{j , t} = {β}_{p}^{j} ( {k}_{p}^{j} {T}_{in}^{j , t - {γ}_{p}^{j}} + ( 1 - {k}_{p}^{j} ) {T}_{in}^{j , t - {γ}_{p}^{j} - 1} ) + ( 1 - {β}_{p}^{j} ) {T}_{amb}^{t}$$
wherein t is a scheduled period set; j is a pipe set; parameters γₚ^{j} and kₚ^{j} are coefficients of the pipe j that are related to a transmission delay; βₚ^{j} is a heat preservation coefficient; T_{amb}^{t} is a pipe ambient temperature at a moment t; Tᵢₙ^{j,t} and Tₒᵤₜ^{j,t} are respectively temperatures of a heat medium at a pipe inlet and outlet at the moment t; and
calculation formulas of the parameters γₚ^{j}, kₚ^{j}, and βₚ^{j} are as follows:
$$\{ \begin{matrix}{γ}_{p}^{j} = ⌈ {ρ}_{w} {A}_{p}^{j} {L}_{p}^{j} / ( {m}_{p}^{j} Δ t ) ⌉ - 1 \\ {k}_{p}^{j} = {γ}_{p}^{j} + 1 - {ρ}_{w} {A}_{p}^{j} {L}_{p}^{j} / ( {m}_{p}^{j} Δ {t}_{h} ) \\ {β}_{p}^{j} = 1 - exp ( - {ζ}_{p}^{j} Δ t / ( {ρ}_{w} {c}_{w} {A}_{p}^{j} ) ( {γ}_{p}^{j} + 3 / 2 - {k}_{p}^{j} ) )\end{matrix}$$
wherein Δt is a time interval; ρ_{w} is a density of the heat medium; c_{w} is a specific heat capacity of the heat medium; Aₚ^{j} is a cross-sectional area of the pipe j; Lₚ^{j} is a length of the pipe j; ζₚ^{j} is a pipe heat loss coefficient; mₚ^{j} is a mass flow rate of the heat medium of the pipe; and ┌⋅┐ is a round-up function; and
establishing a thermal dynamic model of the building:
$${T}_{b}^{k , t} = {α}_{b}^{k} {T}_{b}^{k , t - 1} + {β}_{b}^{k} {H}_{L}^{k , t} + {γ}_{b}^{k} {T}_{out}^{t}$$
wherein k is a building set; and α_{b}^{k}, β_{b}^{k} and γ_{b}^{k} are parameters that depend on a heat capacity and thermal resistance of the building.

4. The static voltage stability margin evaluation method according to claim 1, wherein the solving the static voltage stability margin model to obtain a voltage stability margin comprises the following steps:
optimizing the static voltage stability margin model as:
λ_{E}(ε)=max λ_{E}
s.t. λ_{H}=ε
g_{E}≤0,g_{H}≤0,g_{EH}≤0
wherein ε is a constant for predefining λ_{H}; and
initializing ε=0, Flag=1, k=0, and Δε, and performing solving according to the following cycle step,
wherein the cycle step comprises:
updating λ_{H}^{k}←ε, and calculating a mass flow rate m_{p,c}_{₁}^{j}, and parameters γₚ^{j}, kₚ^{j}, and βₚ^{j};
solving the optimized static voltage stability margin model; and if there is a solution, updating λ_{E}^{k}←λ_{E}(λ_{H}^{k}); otherwise, updating Flag←0;
updating k←k+1, ε←ε+Δε; and
if Flag=1, repeating the cycle step; or if Flag=, exiting the cycle step.

5. The static voltage stability margin evaluation method according to claim 1, wherein the thermoelectric coupling device model comprises an operation constraint of a combined heat and power unit, a coupling constraint between the combined heat and power unit and a heating network, and a water temperature constraint of the heating system.

6. The static voltage stability margin evaluation method according to claim 5, wherein the coupling constraint between the combined heat and power unit and the heating network is as follows:
$${H}_{chp}^{i , t} = {c}_{w} {m}_{src}^{i , t} ( {T}_{src , s}^{i , t} - {T}_{src , r}^{i , t} )$$
wherein m_{src}^{i,t} is a mass flow rate of a heat source; and T_{src,s}^{i,t} and T_{src,r}^{i,t}, are respectively a supply water temperature and a return water temperature of the heat source.

7. The static voltage stability margin evaluation method according to claim 5, wherein the water temperature constraint of the heating system is as follows:
T_{src,s}ⁱ≤T_{src,s}^{i,t}≤T̅_{src,s}ⁱ,T_{src,r}ⁱ≤T_{src,r}^{i,t}≤T̅_{src,r}ⁱ
where T_{src,s}ⁱ and T̅_{src,s}ⁱ are respectively a lower limit and an upper limit of a supply water temperature of a heat source; and T_{src,r}ⁱ and T̅_{src,r}ⁱ are respectively a lower limit and an upper limit of a return water temperature of the heat source.

8. A static voltage stability margin evaluation system using the static voltage stability margin evaluation method according to claim 1, comprising:
a thermal dynamic model module of a heating system, configured to establish a thermal dynamic model of the heating system based on temperature transmission of a heating network pipe and thermal dynamics of a building;
a thermoelectric coupling device model module, configured to establish a thermoelectric coupling device model based on operation and a coupling constraint of a thermoelectric coupling device;
a static voltage stability margin model module, configured to establish, based on an electric load growth mode and a thermal load growth mode, a static voltage stability margin model; and
a calculation module, configured to solve the static voltage stability margin model based on the thermal dynamic model module of the heating system, the thermoelectric coupling device model module, and the static voltage stability margin model module, to obtain a voltage stability margin.

9. A terminal device, comprising a memory, a processor, and a computer program stored in the memory and executable on the processor, the processor, when loading and executing the computer program, using the static voltage stability margin evaluation method according to claim 1.

10. A computer-readable storage medium, storing a computer program, the computer program, when being loaded and executed by the processor, using the static voltage stability margin evaluation method according to claim 1.
